(19) United States
(12) Patent Application Publication
(10) Pub. No.: US 2008/0178090 A1
(43) Pub. Date: Jul. 24, 2008

(54) Universal Medical Imager

(76) Inventors: Ajay Mahajan, Murphysboro, IL (US); Gery Hsu, Wichita, KS (US); Sumeer Lal, Craatwood, SC (US)

Correspondence Address: WILSON DANIEL SWAYZE, JR., 3804 CLEARWATER CT., PLANO, TX, 75025, US

(21) Appl. No.: 11/744,711

(22) Filed: May 4, 2007

Related U.S. Application Data
(60) Provisional application No. 60/840,489, filed on Aug. 28, 2006.

(51) Int. Cl. G06F 3/00

(52) U.S. Cl. 715/733

(57) ABSTRACT

A medical viewing device includes a primary viewing box for displaying medical records including a first processor to control the primary viewing box, a CD/DVD driver to drive a CD/DVD which includes the medical records and a first touched screen to display the medical records. The medical viewing device further including a secondary viewing box for displaying the medical records from the primary viewing box which includes a second processor to control the secondary viewing box and a second touch screen to display the medical records from the primary viewing box.

### PRIORITY

The presently claimed invention claims priority under 35 USC section 119 and based on provisional application Ser. No. 60/840,489 which was filed on Aug. 28, 2006.

### FIELD OF THE INVENTION

The present invention relates to image technology and more particularly to an apparatus and method for displaying medical images.

### BACKGROUND

The use of image technology has greatly enhanced the field of medicine providing sharper and more detailed imaging and improved safety for patients. Current x-ray technology and radiology improvements have enabled physicians to diagnose and treat pathology that has been previously unknown or not appreciated. Over the years, further developments in image technology and image processing have developed even more complex systems such as the CT scan, PET scan, ultrasonography and magnetic resonance imaging (MRI). With each new development, the physician's armamentarium has increased and allows him to look further into the workings of the human body.

Despite the obvious advantages of new technology, there is a delay in application of the technology by most physicians. Most doctors simply can't keep up with the technological innovations that emerge almost daily. Currently in the United States, many x-ray images, regardless of type (i.e. CT scan, MRI, angiography, ultrasound etc.), are digitized, are placed on a CD/DVD and are given to the patient. These discs are then brought to the specialist for review and discussed during the consultation with the doctor. Previously, patients were given a ‘hardcopy’ of the images, and the films were viewed by the physician on an x-ray box (also called an x-ray illuminator). The use of these films is decreasing due to the following reasons:
1) the cost of x-ray film,
2) the cost of developing the film,
3) many x-ray studies have hundreds of images making the entire study very large, cumbersome and heavy,
4) there are multiple imaging centers often contributing to the evaluation of a patient, and
5) the quality and versatility of the digitized images are far superior to the printed copies.

Presently, viewing these x-ray images is very difficult, cumbersome and time consuming. The disc, given to the clinician by his or her patient, must be taken to the physician's private office or work station away from the clinic. Because of the different formats for viewing the x-ray images, software may be required to be uploaded, and consequently, the images cannot be viewed with the patient. This has increased the level of frustration among physicians, and unfortunately this problem is growing. What is required is to change how physicians view radiographic images.

Some existing systems are disclosed below. One equipment manufacture who is the most prominent is Barco.
http://www.pnwx.com/Equipment/Digital/Displays/Barco/ImageTile/
http://www.pnwx.com/Equipment/Digital/Displays/Barco/Nio/
http://www.pnwx.com/Equipment/Digital/Displays/Barco/Coronis/
http://www gordon-instruments.com/digital_illuminator.html
http://www.quickmedical.com/wolf_xray/illuminators/trimline_series_specifications.html

### SUMMARY

An x-ray view box called the Universal Medical imager (UMI) is disclosed. The UMI station will utilize a screen which may be of varying sizes and conforms to present standards of x-ray illuminators. These will in essence be monitors that will show images that have been downloaded on the device itself. A CD/DVD port will be included, and x-ray images will be directly available for viewing by being downloaded from the CD/DVD port. A portion of these x-ray images may be desired, for example, to be enlarged or moved about with the screen. This function is accomplished by using a touch screen. Eventually, a portion of the images could potentially be wirelessly sent to other view boxes in the examining rooms as well. Existing software may be embedded into the processor within the screen and/or a universal program could be developed to download the images from existing CD/DVDs.

The view boxes could also act as ‘a traditional x-ray boxes’ by allowing x-ray/MRI hardcopies to be viewed on them in a conventional way by “hanging” the hardcopy on the screen and having the screen emit a white light to allow the physician to view the images.

A combination of a single “primary” and multiple “secondary” units could form a bank of units that are any number of units long such as 1 to 6 units long. The secondary units may have all the functionality of the primary units or have reduced functionality but still have the ability to communicate with the primary unit, so as to transfer images from one screen to another. Another implementation of the UMI would be for physicians to view “movies” such as multiple images of a EKG by cardiologists, etc. for a more efficient diagnosis. The UMI may have touch screen capability, a small keyboard, a touchpad, or a combination of such components to operate the UMI. These units can be used in physician's offices, operating rooms, clinics as well as other such areas. Other applications could be in home entertainment, commercial displays and educational applications.

There are over 10,000 hospitals and over 600,000 physicians in the US alone. Based on those numbers, it is estimated that the market for the UMI could very easily be 1 million “primary” units and 3 million secondary units (average of 1-5 secondary units).

### BRIEF DESCRIPTION OF THE DRAWING

The invention may be understood by reference to the following description taken in conjunction with the accompanying drawings, in which, like reference numerals identify like elements, and in which:

FIG. 1 illustrates a perspective view of the universal digital medical image viewing box in accordance with the teachings of the present invention;

FIG. 2 illustrates a menu for a touch screen for the universal digital medical image viewing box;

FIG. 3 illustrates a front view of the primary unit of the present invention;

FIG. 4 illustrates the primary unit with secondary units;

FIG. 5 illustrates a block diagram of the primary unit of the present invention;

FIG. 6 illustrates a block diagram of the secondary unit of the present invention.

### BRIEF DESCRIPTION

Using a new combination of technology, a form of x-ray view box has been developed called the Universal Medical Imager (UMI).

The UMI station would utilize a screen which can come in various sizes and would conform to present standards of image processing. The UMI station would in essence be monitors with embedded functionality. These monitors would show images downloaded on the device itself. A DVD port would be included to accept DVDs, and images would be directly available for viewing, with certain images, for example, to be enlarged or moved about with a touch screen. Eventually, certain images could potentially be wirelessly sent from where the images are developed/stored to view boxes in the examining rooms as well. This wireless transmission would allow privacy when the physician is discussing the select images with his or her patient. Existing software could be embedded into the processor within the screen and or a universal program could be developed to download the images from existing CD/DVDs.

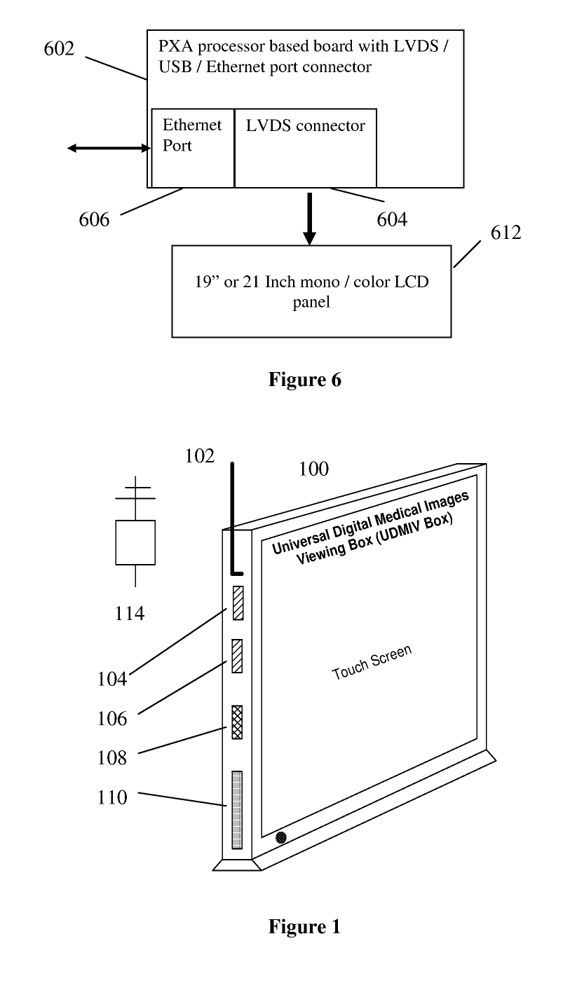

The view boxes could as well act as ‘regular x-ray boxes’ by allowing x-ray/MRI hardcopies to be viewed on them in a conventional way by having the ability to “hang” the hardcopy with a clip on the view box and have the screen emit a white light to allow the physician to view the images. A combination of one “primary” and multiple “secondary” units could form a bank of units anywhere from 1 to 6 units long or longer. The secondary units would simply have the touch screen and the ability to communicate with the primary unit, so as to transfer images from one screen to another. The proposed “primary unit” is shown in FIG. 1.

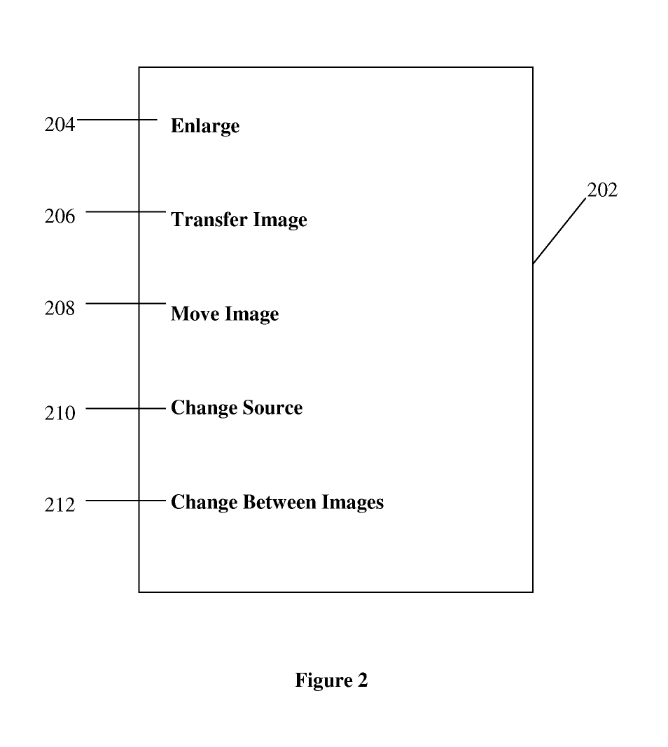

FIG. 1 illustrates a digital Universal Medical Imager (UMI) 100 which is known in the abbreviated form of viewing box 100. The viewing box 100 includes a touch screen 112 to allow predetermined images to the moved or enlarged. FIG. 2 illustrates a menu 202 for controlling the touch screen 112. The menu 202 includes functions such as a enlarge 204 the image, transferor 206 the image, move 208 the image, change 210 the source of the image and change 212 between images.

FIG. 1 additionally illustrates that the viewing box 100 includes an antenna 102 for a wireless connection to a remote station 114 which may be another viewing box so that the viewing box 100 can receive or send images, particularly x-ray images, from or to the remote station 114. The viewing box 100 additionally includes an ethernet port 104 which is a large and diverse family of frame based computer networking technology for local area networks (LANS) and a serial port 106 to accept and transmit serial data. The viewing box 100 additionally includes an Universal Serial Bus USB port to connect to another computer and a CD/DVD drive to accept a CD/DVD which may include x-ray images or other medical information a records.

With the trend to move to more digitized images, and the demand for the viewing box 100 increases, the potential sales for this type of product are very large. This viewing box 100 should eventually save clinicians time and should limit health care costs by helping to eliminate or reduce x-ray processing.

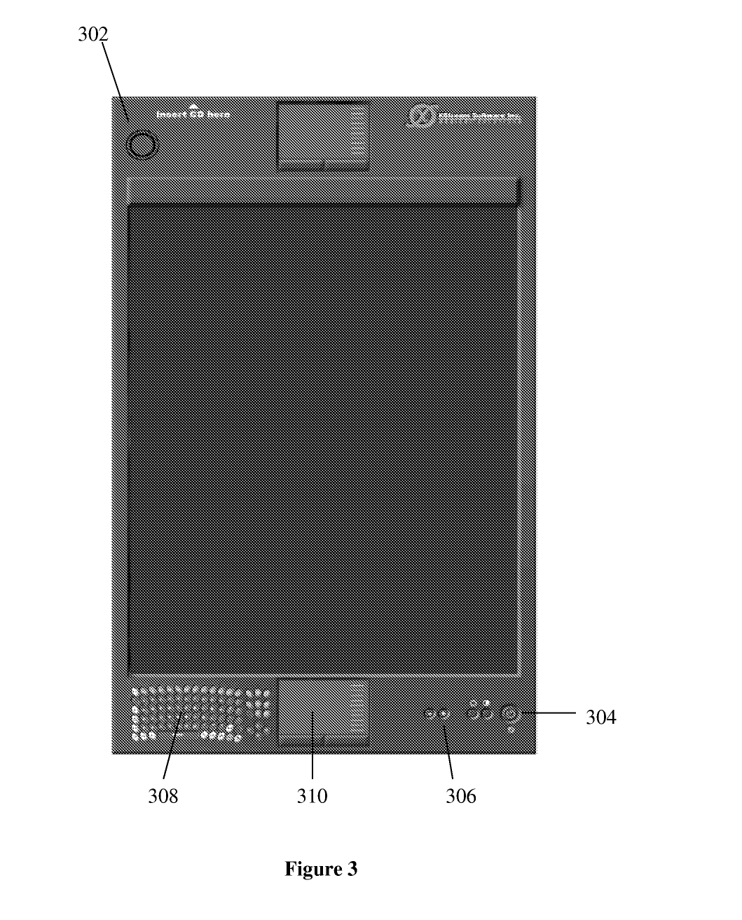

FIG. 3 illustrates a viewing screen 100 in accordance with the teachings of the present invention. The viewing screen 100 includes an on/off switch 304, screen controls 306, keyboard 308, touchpad 310 and a CD/DVD eject button 302. The viewing screen 100 may have all of these devices or a limited combination of these devices

### Extendable Screens

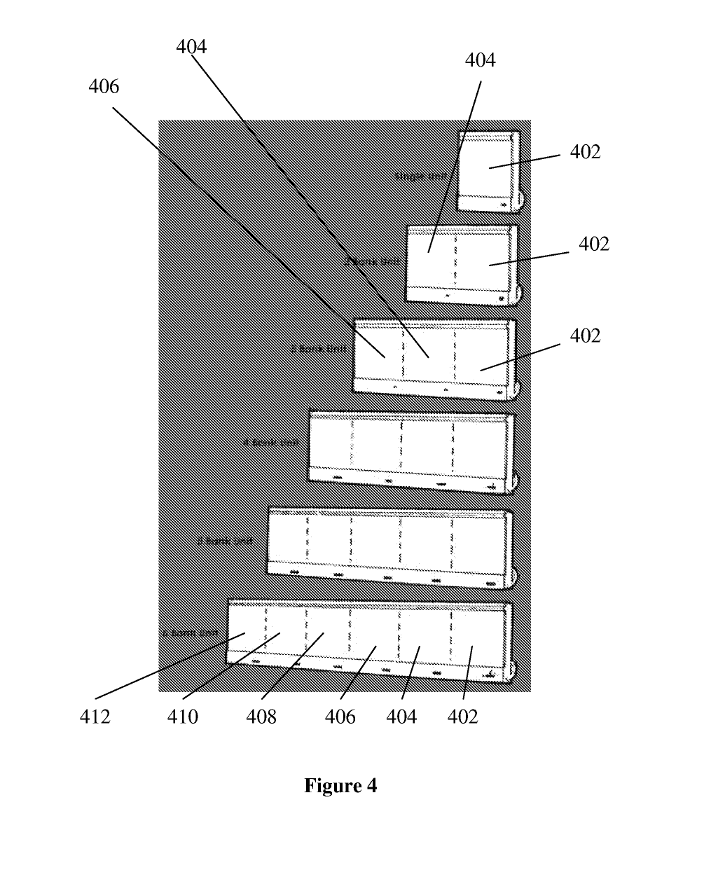

A primary unit may operate independently with all the features described and shown in the diagram. FIG. 4 illustrates the primary unit 402 with additional secondary units being added. The secondary units can then be connected to the primary unit 402. At the top of FIG. 4, the primary unit 402 is operating with no secondary units. Below this, the primary unit 402 is operating with the first secondary unit 404. Below this, the primary unit 402 is operating with the first secondary unit 404 and a second secondary and 406. Successive secondary units can be added as illustrated in FIG. 4. And at the bottom of FIG. 4, the primary unit 402 is connected to the first secondary unit 404 which is connected to the second secondary unit 406 which is connected to a third secondary unit 408 which is connected to a fourth secondary unit 410 and which is connected to a fifth secondary unit 412.

These secondary units 404, 406, 408, 410, 412 can be simpler (hence cheaper) since the secondary units does not necessarily have the CD/DVD player, USB port, serial port, Ethernet port or the wireless connection. The secondary units may only have a single connector that connects them to a primary unit or another secondary unit for data transfer. The end result will be a bank of units comprising of a primary unit and 1, 2, 3, 4 or 5 additional secondary units, very similar to existing illuminator configurations as shown below in the figure.

### Features Set for the UMI

Given below is the features set that may be used for the described invention:

### Primary Unit

| | Features desired | Hardware/software | Specifications |
|---|---|---|---|
| 1 | The ability to view digital | Touch screen | Viewing area |
| | images and use “touch” as the | | of |
| | source of operation | | approximately |
| | | | 14″ × 17″ for a |
| | | | single unit |
| 2 | The resolution may be of the | | Approximately |
| | same quality as a normal PC | | 1-2 MB |
| | screen | | |
| 3 | The ability to read images | CD/DVD player | Approximately |
| | from a CD/DVD | | 24x or 48x |
| 4 | The ability to show the | Video card | Equivalent to a |
| | images on the screen | | Pentium 3/4 |
| 5 | Connect to another computer | USB port | USB 2.0 |
| | thru a USB port | | |
| 6 | Connect to another computer | Serial port | Up to |
| | thru a serial port | (RS232-RS485) | approximately |
| | | | 115K bits/sec |
| 7 | Ethernet connection to | Ethernet port | At least 100 |
| | directly connect to a remote | | MB |
| | server | | |
| 8 | Wireless connection that may | Antenna and | Frequency of |
| | supercede the physical | Embedded | approximately |
| | connections | circuitry | 1.5 GHz |
| 9 | A dedicated microprocessor, | Microprocessor and | Clock speed is |
| | e.g. a PIC microcontroller | the software could | near 12-40 MB |
| | RCM3300 since it has an | be Microchip (MP | and low power |
| | embedded Ethernet | lab) | (5 V) |
| | connection | | |
| 10 | The ability to connect to | Hardwire connector | |
| | secondary units that only | | |
| | have a touch screen and the | | |
| | ability to display images and | | |
| | move images to other | | |
| | successive secondary units | | |
| 11 | The ability to store images | RAM (flash | At least |
| | | memory or SRAM) | approximately |
| | | | 100 MB |
| 12 | The ability to read all types | A universal software | |
| | of images, i.e. written and | that can read and | |
| | displayed by different | display all types of | |
| | software products, for | medical images | |
| | example | | |
| | Kodak | | |
| | Maxtor | | |
| | Imaging Suite | | |
| | Stentor | | |
| | TDK Medical | | |
| 13 | The ability to view traditional | Use the same touch | |
| | X-Rays, MRIs, etc. | screen with white | |
| | | light | |
| 14 | Self contained power, i.e. | AC as well as a 6 V | Substantially |
| | ability to be powered by AC | rechargeable | AC 115 DC |
| | (or internal battery for short | battery - | 6 V |
| | durations - this may not be | again the battery | |
| | necessary) | option may not be | |
| | | necessary. | |
| 15 | User selectable button for | Hardware/software | |
| | switching on and off as well | switches | |
| | as selecting options for data | | |
| | input | | |

Note:
The secondary units may only have features 1, 2, 9, 10, 11, 12, 13 and 14.

### System Architecture

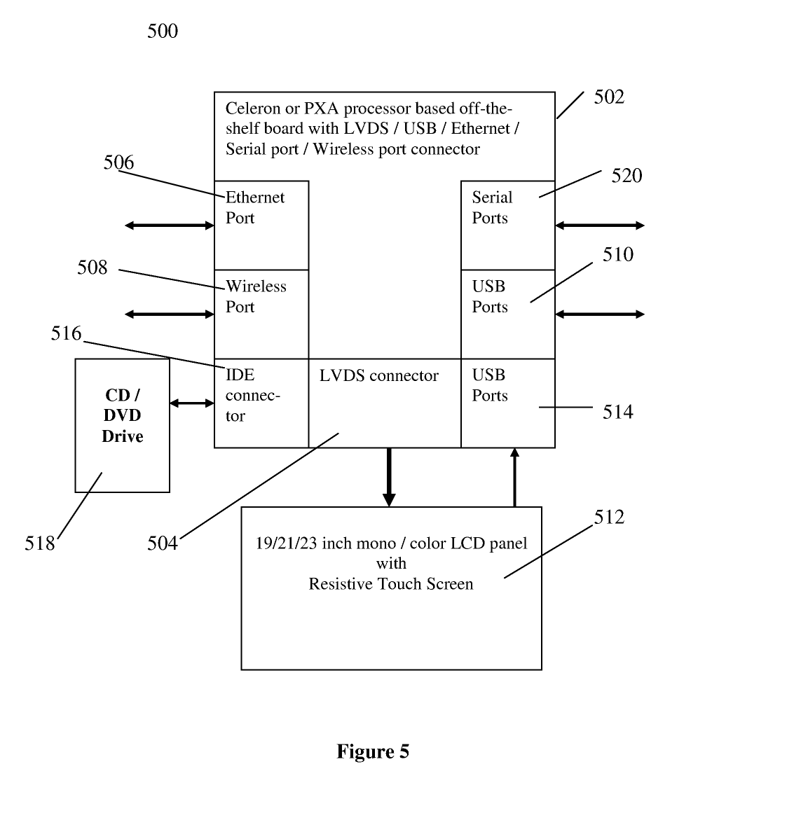

FIG. 5 illustrates a block diagram of the primary unit.

The system includes a main unit 500, which will interact with the other medical systems to get the images and display them on the LCD panel 512 using standard viewers available in the industry. The touch panel 512 will allow the doctor to use various tools to change (zoom in/out, rotate, etc) the display. This main unit 500 will connect to other secondary units 404, 406, 408, 410, 412 to display multiple images. The viewing area mentioned is 14″×17″ which approximately translates to a 19, 21 or 23″ LCD screen. Other viewing areas could be employed by the present invention.

The system will include a standard industrial processor module 502 with low voltage differential signaling LVDS connector 504 for connecting the LCD panel 512, at least one Ethernet port 506 for connecting to other medical systems and for connecting to the secondary units 404, 406, 408, 410, 412, a wireless port 508 which may be a mini PCI connector for inserting a 802.11 wireless module or a PCMCIA connector for inserting a wireless card, a first Universal Serial Bus USB port 510 for an external connection and a second Universal Serial Bus USB port 514 for interfacing with the panel 512, an IDE connector for connecting a internal hard disk/external CD/DVD drive 518 and at least one serial port for external connections.

This board will run either Linux OS, Windows CE, Embedded XP or other operating systems to display the images and interfacing to the other medical systems.

FIG. 6 illustrates the block diagram for the secondary units 404, 406, 408, 410, 412. The secondary units 404, 406, 408, 410, 412 may include a microprocessor core such as a PXA processor 602, a LVDS connector 604 for connecting the LCD panel 612, and a Ethernet port 606 for connecting to the Primary viewing box 100. The processor 602 may run either Linux OS, Windows CE, Embedded XP or other suitable software to display the images and interfacing to the Primary viewing box 100.

This secondary unit receives the image file from the primary viewing box 100 to display the received images on the screen. All the secondary units 402, 404, 406, 408, 410, 412 can be tiled together (physically) or may be in different locations and will be connected to the primary viewing box through the Ethernet port 606. The main unit can split the image and display it on multiple units or display multiple images on different secondary units.

### Benefits of the UMI

The present invention provides significant time-saving and hence cost savings. The present invention includes a system that is designed for images. The system loads instantly and is easy to use, avoiding fussing around and bending down.

The present invention is efficient in managing, transferring, viewing and manipulating medical images. The present invention includes touch screen capability which provides an immediate response. And because the information can be displayed in a doctor's office, clinics and operating rooms without a workstation, the present invention allows the doctor to converse with the patient and efficiently help the patient.

The present invention provides a central medium for viewing all different types of images (no special-purpose software required) and a dedicated image viewer which can be used for both internal and external images. The present invention should be security enabled to protect against virus.

The vertical presentation of the screen, the screen and CPU in a single configuration and no cables except for power cable provide for saving space. Additionally, the present invention provides a slick design with touch screen capabilities.

The medical viewer is patient comforting by providing high-resolution to demonstrate images, by providing a mouse and keyboard free environment which allows the doctor to concentrate on the patient discussion and by providing a pleasing look and feel of the screen. In the operating room, a sterile stylus or gloved hand may be needed.

The medical viewer of the present invention is user friendly by providing a no fuss operation; the CD/DVD loads instantly with an easy CD/DVD loader and includes touch screen and wireless components.

The system is specifically design to allow easy access in viewing the CD/DVD's from an external medical facility. The facility can be either from an x-ray lab, cat scan facility, MRI facility or any other medical facilities. The UMI is designed to ease the installation of the disc by having a front end accessible CD/DVD reader. The reader is fast at the speed of 52×, it will recognize the CD and load the images quickly.

The touch screen will allow the Doctor to scroll through the images or drill down depending of the images viewing software loaded on the disc. The doctor could easily open the CD with the any number of the viewers installed in the UMI.

The touch screen will allow the Doctor to concentrate on his conversion with the patient rather than trying to manipulate the keyboard and mouse. The high resolution screen will allow the patient to clearly see the images from any angle. This also makes it easy in the operating room for immediate access to images of the patient.

The present invention is an easy to use built unit with user-friendly computer interface. The user is able to view and manipulate medical images originating from different scanning stations as CT scan, PET scan, ultrasonography, and magnetic resonance imaging (MRI). The present invention allows a user to load a CD/DVD into the unit to display an interactive function menu, which allows you to launch the content and browse the options.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A medical viewing device, comprising:
a primary viewing box for displaying medical records, including:
a first processor to control the primary viewing box;
a CD/DVD driver to drive a CD/DVD which includes the medical records;
a first touch screen to display the medical records; and
the medical viewing device further comprising:
a secondary viewing box for displaying the medical records from the primary viewing box, including:
a second processor to control the secondary viewing box;
a second touch screen to display the medical records from the primary viewing box.

2. As in claim 1, wherein said primary viewing box includes an ethernet port.

3. A medical viewing device as in claim 1, wherein said primary viewing box includes a wireless port for wireless connection to another primary viewing box.

4. A medical viewing device as in claim 1, wherein said primary viewing box includes an USB port.

5. A medical viewing device as in claim 1, wherein said primary viewing box includes a LVDS connector to connect to the first touch screen.

6. A medical viewing device as in claim 1, wherein said first touch screen is adapted enlarge the medical record.

7. A medical viewing device as in claim 1, wherein said first touch screen is adapted to transfer images of the medical records to the secondary viewing box.

8. A medical viewing device as in claim 1, wherein the first touch screen is adapted to move images of the medical records on the screen.

9. A medical viewing device as in claim 1, wherein the first touch screen is adapted to change source.

10. A medical viewing device as in claim 1, wherein the first touch screen is adapted to change between images.

11. A medical viewing device as in claim 1, wherein said second touch screen is adapted to enlarge the medical record.

12. A medical viewing device as in claim 1, wherein said second touch screen is adapted to transfer images of the medical records to in other secondary viewing box.

13. A medical viewing device as in claim 1, wherein the second touch screen is adapted to move images of the medical records on the secondary touch screen.

14. A medical viewing device as in claim 1, wherein the second touch screen is adapted to change source.

15. A medical viewing device as in claim 1, wherein the second touch screen is adapted to change between images.
